(19) United States
(12) Patent Application Publication
(10) Pub. No.: US 2023/0354151 A1
(43) Pub. Date: Nov. 2, 2023

(54) CELLULAR TELECOMMUNICATIONS NETWORK

(71) Applicant: BRITISH TELECOMMUNICATIONS PUBLIC LIMITED COMPANY, London (GB)

(72) Inventor: Salvador DIAZ SENDRA, London (GB)

(21) Appl. No.: 17/907,379

(22) PCT Filed: Feb. 5, 2021
(86) PCT No.: PCT/EP2021/052814

§ 371 Date: Sep. 26, 2022

(30) Foreign Application Priority Data
Mar. 25, 2020 (EP) 20165488.6
Mar. 25, 2020 (GB) 2004300.6

(51) Int. Cl. H04W 40/22

(52) U.S. Cl. CPC H04W 40/22; H04W 92/20

(57) ABSTRACT

This disclosure relates to a method of operating an Access Point (AP) in a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, the method including receiving an inter-AP message in a first wireless communication from a first AP of the plurality of APs, the inter-AP message comprising a destination identifier; identifying a second AP of the plurality of APs based on the destination identifier of the inter-AP message; and sending the inter-AP message to the second AP in a second wireless communication via the wireless downstream connection.

### PRIORITY CLAIM

The present application is a National Phase entry of PCT Application No. PCT/EP2021/052814, filed Feb. 5, 2021, which claims priority from EP Patent Application No. 20165488.6, filed Mar. 25, 2020 and GB Patent Application No. 2004300.6, filed Mar. 25, 2020, each of which is hereby fully incorporated herein by reference.

### TECHNICAL FIELD

The present disclosure relates to a cellular telecommunications network.

### BACKGROUND

In a cellular telecommunications network, overall capacity may be improved by increasing the density of base station deployment. However, there is an associated capital expense in providing both the additional base station equipment and the wired links connecting the additional base stations with the core network (the “backhaul”). To reduce the backhaul expenditure, access connections may be provided by relay nodes which utilize a wireless backhaul link to the core network (via a “donor” base station). Such relay nodes have become part of the 4G standards. One limitation of these 4G relay nodes is that there may only be a single relay node between the User Equipment (UE) and the donor base station (i.e. they are “single-hop”).

In 5G, relay nodes are called “Integrated Access and Backhaul” (IAB) nodes and the donor base station is called the donor IAB. 5G networks may also employ multi-hop architectures so that multiple IAB nodes may exist between the UE and the donor IAB.

Collectively, any form of networking node that may provide an access connection in a cellular telecommunications network may be known as an Access Point (AP). This term includes the base station, donor base station, relay node, IAB node and donor IAB described above.

Cellular telecommunications networks also utilize inter-AP messaging protocols, such as X2 in 4G and Xn in 5G. These protocols allow connections to be established between APs (directly or indirectly) in order to exchange messages concerning mobility management, load management and various configuration parameters. The donor base station in 4G networks or the donor IAB in 5G networks are responsible for routing the inter-AP messages (or have a connection to a gateway node providing such functionality), including for inter-AP messages originating from any relay node or IAB node that they serve.

### SUMMARY

According to a first aspect of the disclosure, there is provided a method of operating an Access Point (AP) in a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, the method comprising receiving an inter-AP message in a first wireless communication from a first AP of the plurality of APs, the inter-AP message comprising a destination identifier; identifying a second AP of the plurality of APs based on the destination identifier of the inter-AP message; and sending the inter-AP message to the second AP in a second wireless communication via the wireless downstream connection.

The second AP may be the destination of the inter-AP message or a first neighbor of the second AP.

The method may further comprise discovering the second AP; identifying the first neighbor of the second AP; recording an association between the second AP and the first neighbor of the second AP, wherein the step of identifying the second AP based on the destination of the inter-AP message utilizes the recorded association between the second AP and the first neighbor of the second AP.

The method may further comprise detecting a termination of an inter-AP connection between the second AP and a second neighbor of the second AP; and responsive to the detection, updating a recorded association between the second AP and the second neighbor of the second AP.

According to a second aspect of the disclosure, there is provided a computer program comprising instructions which, when the program is executed by a computer, cause the computer to carry out the first aspect of the disclosure. The computer program may be stored on a computer readable carrier medium.

According to a third aspect of the disclosure, there is provided an Access Point (AP) in a cellular telecommunications network having a transceiver, memory and a processor configured to cooperate to carry out the first aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a cellular telecommunications network of the present disclosure.

FIG. 2 is a schematic diagram of a donor Integrated Access and Backhaul (IAB) of the network of FIG. 1.

FIG. 3 is a schematic diagram of an IAB node of the network of FIG. 1.

FIG. 4 is a flow diagram illustrating a message transfer process of an embodiment of a method of the present disclosure.

FIG. 5 is a schematic diagram of the network of FIG. 1 following introduction of a fifth IAB node.

FIG. 6 is a flow diagram illustrating a routing table update process of the embodiment of the method of the present disclosure.

### DETAILED DESCRIPTION OF EMBODIMENTS

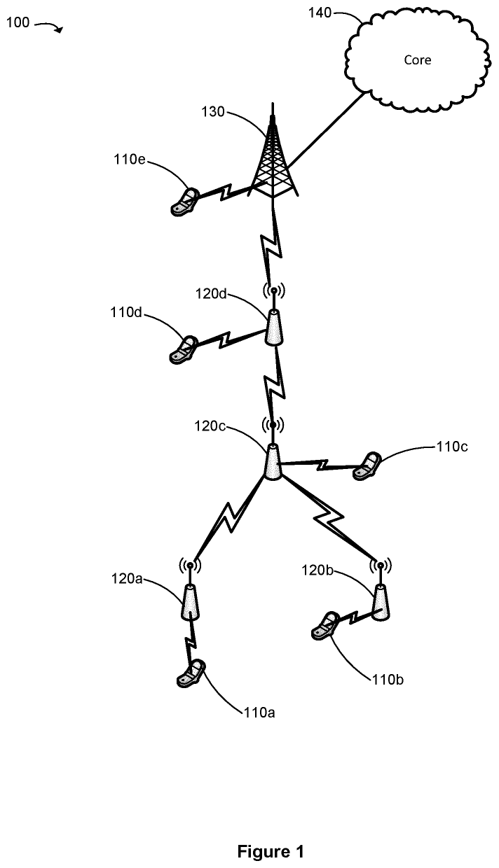

A first embodiment of a cellular telecommunications network 100 of the present disclosure will now be described with reference to FIGS. 1 to 3. FIG. 1 illustrates a cellular telecommunications network 100 including a plurality of User Equipment (UE) 110a . . . 110e, a plurality of Integrated Access and Backhaul (IAB) nodes 120a . . . 120d, a donor IAB 130 and a core network 140, all operating according to the 5^{th} Generation (5G) cellular telecommunications protocol as standardized by the 3^{rd} Generation Partnership Project (3GPP). The IAB nodes 120a . . . 120d are connected in a multi-hop relay architecture so that a first IAB node 120a and second IAB node 120b communicate with the donor IAB 130 via intermediate IAB nodes (the third IAB node 120c and fourth IAB node 120d).

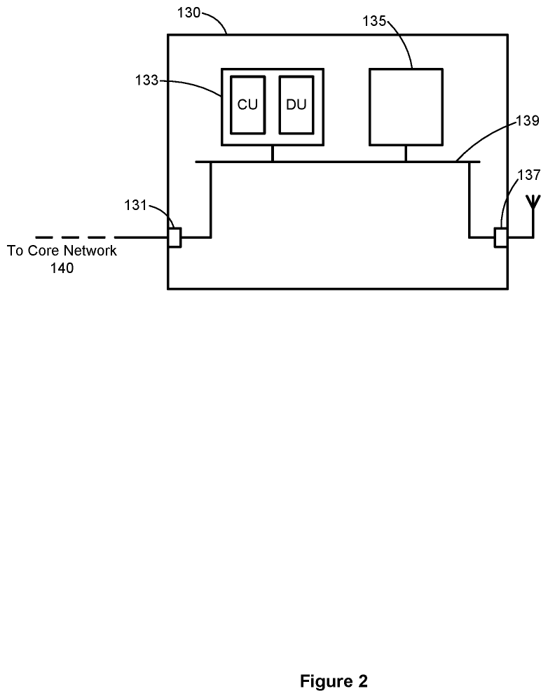

The donor IAB 130 is shown in more detail in FIG. 2. The donor IAB 130 includes a first communications interface 131 for wired communications (e.g. via optical fiber) to the core network 140, a processor 133, memory 135, and a second communications interface 137 for wireless communications (e.g. via an antenna), all connected via bus 139. The second communications interface 137 is for providing an access connection to one or more UE (such as a fifth UE 110e of the plurality of UE), and for providing a wireless backhaul connection to one or more IAB nodes (such as the fourth IAB node 120d). As shown in FIG. 2, the processor 133 of the donor IAB 130 includes both a Centralized Unit (CU) (providing Radio Resource Control (RRC) and Packet Data Convergence (PDC) functionality) and a Distributed Unit (DU) (providing Radio Link Control (RLC) and Medium Access Control (MAC) functionality) for processing packets communicated via the first or second communications interfaces 131, 137.

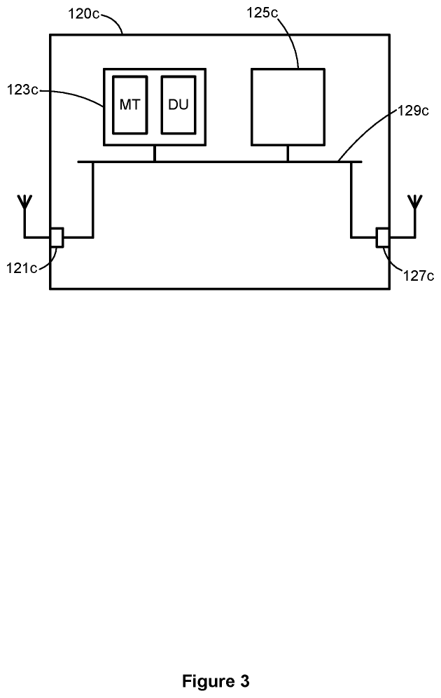

A third IAB node 120c of the plurality of IAB nodes is shown in more detail in FIG. 3. The third IAB node 120c includes a first communications interface 121c for wireless communications (e.g. via an antenna), a processor 123c, memory 125c, and a second communications interface 127c for wireless communications (e.g. via an antenna), all connected via bus 129c. The first communications interface 121c is for providing a wireless backhaul connection to the fourth IAB node 120d. The second communications interface 127c is for providing a wireless access connection to one or more UE (such as the third UE 110c of the plurality of UE) and for providing a wireless backhaul connection to the first and second IAB nodes 120a, 120b. As both the first and second communications interfaces may be utilized for wireless backhaul connections but in opposing directions, the first communications interface 121c to a wireless backhaul connection to the fourth IAB node 120d shall hereinafter be referred to as an upstream wireless backhaul connection (as it is for communications from the third IAB node 120c to upstream network nodes such as the fourth IAB node 120d or the core network 140) and the second communications interface 127c to a wireless backhaul connection to the first and second IAB nodes 120a, 120b shall hereinafter be referred to as a downstream wireless backhaul connection (as it is for communications from the third IAB node 120c to downstream network nodes such as the first and second IAB nodes 120a, 120b).

The processor 123c of the third IAB node 120c includes a Distributed Unit (DU) (providing Radio Link Control (RLC) and Medium Access Control (MAC) functionality) for processing packets communicated via the first or second communications interfaces 121c, 127c, and further includes a Mobile Termination (MT) part for communications via the upstream wireless backhaul connection (to the DU part of the fourth IAB node 120d).

The first, second and fourth IAB nodes 120a, 120b, 120d are substantially the same as the third IAB node 120c, and the terms upstream/downstream wireless backhaul connections for these IAB nodes refer to the upstream/downstream directions from the perspective of each IAB node (that is, the upstream wireless backhaul connection for the first IAB node 120a is towards the third IAB node 120c, the upstream wireless backhaul connection for the second IAB node 120b is towards the third IAB node 120c, the upstream wireless backhaul connection for the fourth IAB node 120d is towards the IAB donor 130, and the downstream wireless backhaul connection for the fourth IAB node 120d is towards the third IAB node 120c).

The donor IAB 130 and the IAB nodes 120a . . . 120d are all configured to establish an inter-Access Point (inter-AP) connection (in this embodiment, an Xn connection) with any other donor IAB or IAB node that they may connect with (directly or indirectly). Furthermore, the donor IAB 130 and each IAB node of the plurality of IAB nodes 120a . . . 120d store (in their respective memory modules) a routing table listing each neighboring node it has an established inter-AP connection with (i.e. an established Xn connection). For each of these neighboring nodes, the routing table further identifies an Internet Protocol (IP) address for the neighboring node, an identifier for the parent node of the neighboring node, and an identifier for each child node of the neighboring node. In this context, a parent node is either a donor IAB or IAB node that the neighboring node is directly connected to via its upstream wireless backhaul connection, whilst a child node is either a donor IAB or IAB node that the neighboring node is directly connected to via its downstream wireless backhaul connection. The process of updating the routing table will be described in more detail below.

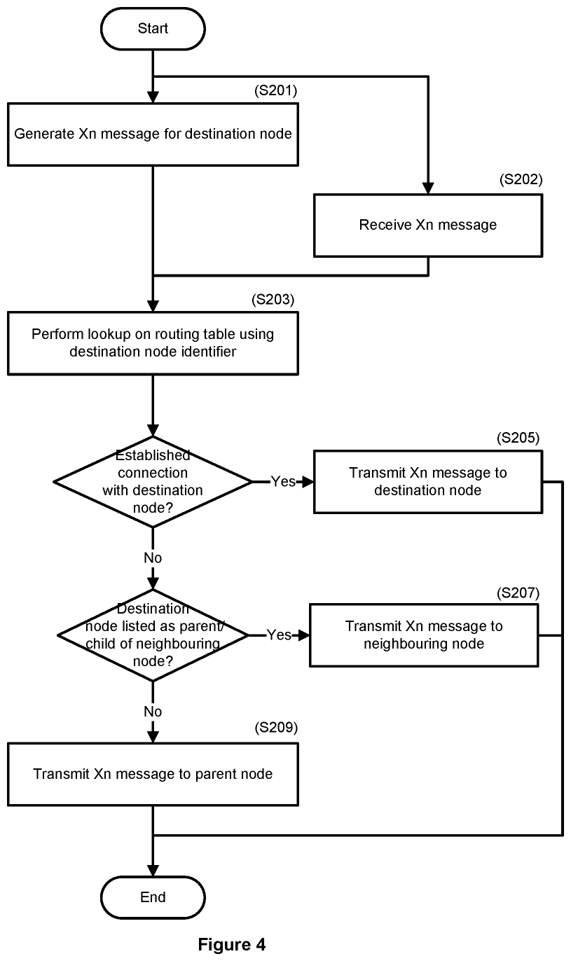

An embodiment of a method of the present disclosure will now be described. This method includes several processes, including a message transport process and a routing table update process. The message transport process will now be described with reference to FIGS. 1 and 4.

The cellular telecommunications network 100 is initially in the state as shown in FIG. 1 and Xn connections have been established between:
The first IAB node 120a and the third IAB node 120c;
The second IAB node 120b and the third IAB node 120c;
The third IAB node 120c and the fourth IAB node 120d; and
The fourth IAB node 120d and the IAB donor 130.

The routing table of the first IAB node 120a includes the following data (following the update process described below):

TABLE 1
Routing table of first IAB node 120a

| | IP Address of | Parent Node of | Child Node(s) of |
|---|---|---|---|
| Neighboring | Neighboring | Neighboring | Neighboring |
| Node | Node | Node | Node |
| Third IAB node | IP_{120c} | Fourth IAB node | First IAB node |
| 120c | | 120d | 120a; |
| | | | Second IAB node |
| | | | 120b |

The routing table of the third IAB node 120c includes the following data (following the update process described below):

TABLE 2
Routing table of third IAB node 120c

| | IP Address of | Parent Node of | Child Node(s) of |
|---|---|---|---|
| Neighboring | Neighboring | Neighboring | Neighboring |
| Node | Node | Node | Node |
| First IAB node | IP₁₂₀ₐ | Third IAB node | NULL |
| 120a | | 120c | |
| Second IAB node | IP_{120b} | Third IAB node | NULL |
| 120b | | 120c | |
| Fourth IAB node | IP_{120d} | IAB donor 130 | Third IAB node |
| 120d | | | 120c |

In S201 of the message transport process, as shown in the flow diagram of FIG. 4, the first IAB node 120a generates an Xn message destined for the second IAB node 120b. In S203, the first IAB node 120a performs a lookup on its routing table to determine whether the first IAB node 120a has an established Xn connection with the second IAB node 120b (that is, it is listed as a neighboring node in the routing table) or whether the second IAB node 120b is a parent or child node of a neighboring node listed in the routing table. In this embodiment, the first IAB node 120a does not have an established Xn connection with the second IAB node 120b but the second IAB node 120b is identified as a child node of the third IAB node 120b. In response (in step S207), the first IAB node 120a transmits the Xn message to the third IAB node 120c.

On receipt of the Xn message from the first IAB node 120a (S202), the third IAB node 120c similarly performs S203 to perform a lookup on its routing table to determine whether it has an established Xn connection with the second IAB node 120b or, if not, whether the second IAB node 120b is a parent or child node of a neighboring node listed in the routing table. As the third IAB node 120c does have an established Xn connection with the second IAB node 120b, the third IAB node 120c responds (in S205) by transmitting the Xn message to the second IAB node 120b.

The second IAB node 120b therefore receives the Xn message and processes it in its normal way.

The above process enables IAB nodes to route inter-AP messages towards their destination. Without this functionality, the IAB node generating the Xn message (the first IAB node 120a) must forward it to the donor IAB 130 so that the Xn message may be forwarded to the destination node (the second IAB node 120b). In this example, the Xn message would have had to be forwarded via the constituent wireless backhaul connections between the first IAB node 120a and the IAB donor 130 (that is, between the first IAB node 120a and the third IAB node 120c, between the third IAB node 120c and fourth IAB node 120d, and between the fourth IAB node 120d and the donor IAB 130). However, by implementing the above process, the Xn message may be forwarded by the third IAB node 120c to the second IAB node 120b, without any interaction of the fourth IAB node 120d or donor IAB 130 and without using the respective wireless backhaul connections between the third IAB node 120c, fourth IAB node 120d and donor IAB 130. The above process therefore frees up capacity on these wireless backhaul connections which would otherwise be wasted forwarding these Xn messages to the donor IAB 130. Furthermore, as these multi-hop architectures may result in a tree structure with further IAB node branches (such as if the third and/or fourth IAB node 120c, 120d had one or more other child IAB nodes) and Xn messages originating within these IAB node branches must also be forwarded up to the IAB donor 130, then any wireless backhaul connection that serves multiple IAB node branches will be significantly burdened. The above process therefore has a more significant benefit for wireless backhaul connections serving multiple IAB node branches.

In another example of the above process in which the first IAB node 120a generates a message destined for a destination IAB node which is not identified in either the first IAB node's routing table or third IAB node's routing table (either as a neighboring node with which they have an established Xn connection or a parent/child node of such a neighboring node), then the first IAB node 120a and third IAB node 120c forward the Xn message towards the JAB donor 130 (step S209). If the fourth IAB node's routing table identifies this destination IAB node, then it may process it according to the steps of the above process. If not, then the Xn message is eventually received and processed by the IAB donor 130.

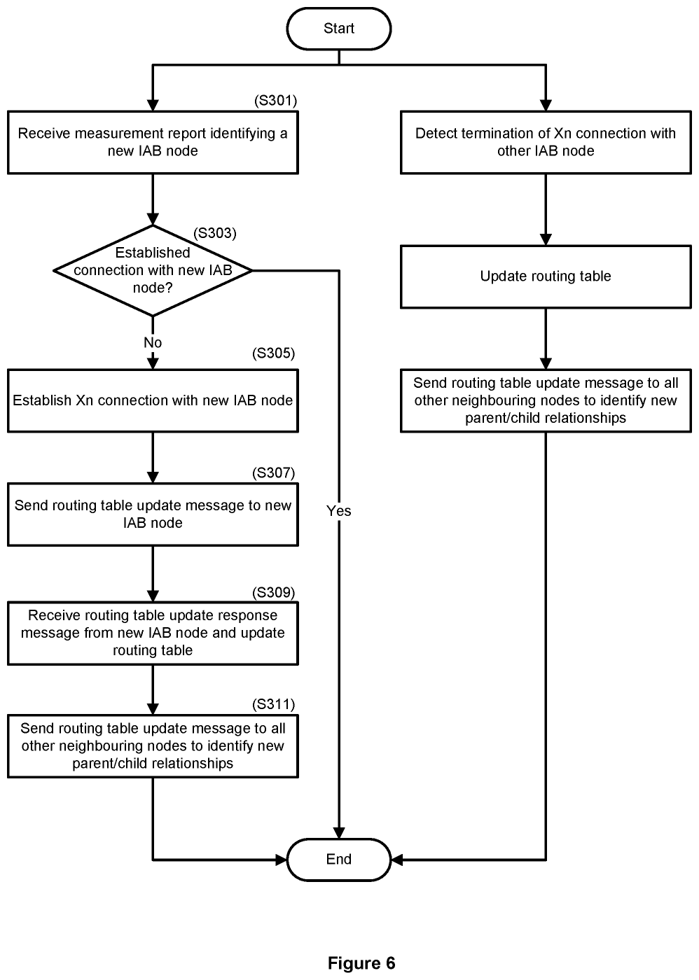

A process of updating the routing table will now be described with reference to FIGS. 1, 5 and 6.

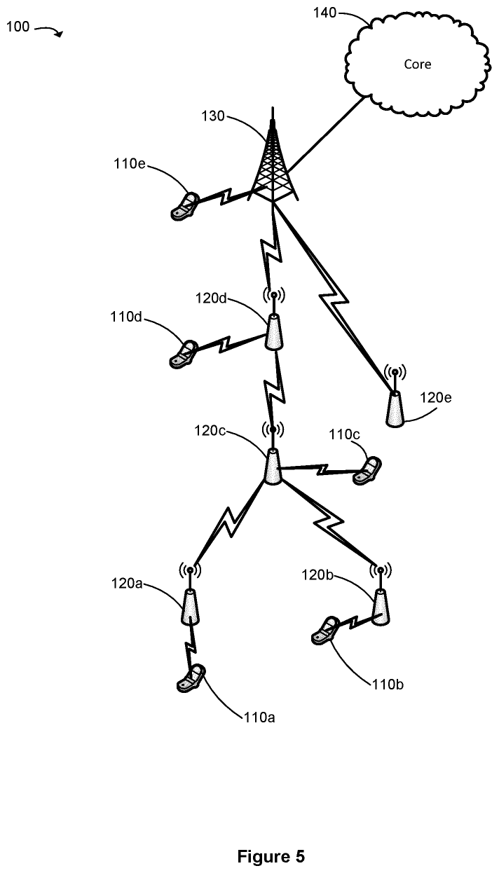

The cellular telecommunications network 100 is initially in the state as shown in FIG. 1. At a subsequent time, a fifth IAB node 120e is added to the network and is connected directly to the donor IAB 130 as shown in FIG. 5. The third UE 110c (connected to the third IAB node 120c) is within the coverage area of the fifth IAB node 120e. In S301 of this routing table update process, the third IAB node 120c receives a measurement report from the third UE 110c identifying the fifth IAB node 120e. In S303, the third IAB node 120c determines whether or not it has an established Xn connection with the fifth IAB node 120e by consulting its routing table. In this example, the third IAB node 120c and fifth IAB node 120e do not have an established Xn connection. In response, the third IAB node 120c begins an Xn connection establishment process with the fifth IAB node 120e (step S305). Once established, the third IAB node 120c has identified the fifth IAB node 120e and has received the fifth IAB node's IP address. Similarly, the fifth IAB node 120e has identified the third IAB node 120c and has received the third IAB node's IP address.

In S307, the third IAB node 120c sends a routing table update message (encapsulated in an Xn message) to the fifth IAB node 120e. This routing table update message identifies the parent node for the third IAB node 120c (in this example, the fourth IAB node 120d) and all child nodes for the third IAB node 120c (in this example, the first and second IAB nodes 120a, 120b).

On receipt, the fifth IAB node 120e stores this data in its routing table. Accordingly, the fifth IAB node's routing table includes the following data:

TABLE 3
Routing table for the fifth IAB node 120e

| | IP Address of | Parent Node of | Child Node(s) of |
|---|---|---|---|
| Neighboring | Neighboring | Neighboring | Neighboring |
| Node | Node | Node | Node |
| IAB donor 130 | IP₁₃₀ | NULL | Fourth IAB node |
| | | | 120d; |
| | | | Fifth IAB node |
| | | | 120e |
| Third IAB node | IP_{120c} | Fourth IAB node | First IAB node |
| 120c | | 120d | 120a; |
| | | | Second IAB node |
| | | | 120b |

The fifth IAB node 120e also sends a routing table update response message (encapsulated in an Xn message) to the third IAB node 120c, identifying the parent node for the fifth IAB node 120e and all child nodes for the fifth IAB node 120e. In this example, the donor IAB 130 is the parent node of the fifth IAB node 120e and there are no child nodes for the fifth IAB node 120e. On receipt, in S309, the third IAB node 130c stores this data in its routing table. Accordingly, the third IAB node's routing table includes the following data:

TABLE 4
Routing table of the third IAB node 120c

| | IP Address of | Parent Node of | Child Node(s) of |
|---|---|---|---|
| Neighboring | Neighboring | Neighboring | Neighboring |
| Node | Node | Node | Node |
| First IAB node | IP₁₂₀ₐ | Third IAB node | NULL |
| 120a | | 120c | |
| Second IAB node | IP_{120b} | Third IAB node | NULL |
| 120b | | 120c | |
| Fourth IAB node | IP_{120d} | IAB donor 130 | Third IAB node |
| 120d | | | 120c |
| Fifth IAB node | IP₁₂₀ₑ | IAB donor 130 | |
| 120e | | | |

Furthermore, in S311, the fifth IAB node 120e sends a routing table update message (encapsulated in an Xn message) to all other neighboring nodes identified in its routing table to identify any new parent/child relationships. There are no new relationships in this example so no such message is required.

The above process provides a mechanism for the routing tables to be updated with information on a newly added IAB node, so that the newly added IAB node may be utilized in the message transport process. Additionally, the process provides for updating routing tables following termination of an Xn connection between IAB nodes from the network (e.g. if an IAB node is removed from the network, powered down, or the Xn connection is otherwise lost). Following detection of a termination, the detecting node sends a message to all other nodes identified in its routing table to inform the other nodes of the termination. The other nodes may then update their routing tables.

In the above embodiment, the inter-base station connections are Xn connections. However, this is non-essential and the above embodiment applies to other forms of inter-AP messages, such as X2 or S1.

The skilled person will understand that any combination of features is possible within the scope of the disclosure, as claimed.

1. A method of operating an Access Point (AP) a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, the method comprising:
receiving an inter-AP message in a first wireless communication from a first AP of the plurality of APs, the inter-AP message comprising a destination identifier;
identifying a second AP of the plurality of APs based on the destination identifier of the inter-AP message; and
sending the inter-AP message to the second AP in a second wireless communication via the wireless downstream connection.

2. The method as claimed in claim 1, wherein the second AP is a destination of the inter-AP message.

3. The method as claimed in claim 1, wherein the destination identifier of the inter-AP message is a first neighbor of the second AP.

4. The method as claimed in claim 3, further comprising, initially:
discovering the second AP;
identifying the first neighbor of the second AP; and
recording an association between the second AP and the first neighbor of the second AP,
wherein identifying the second AP based on the destination identifier of the inter-AP message utilizes the recorded association between the second AP and the first neighbor of the second AP.

5. The method as claimed in claim 1, further comprising:
detecting a termination of an inter-AP connection between the second AP and a second neighbor of the second AP; and
responsive to the detecting, updating a recorded association between the second AP and the second neighbor of the second AP.

6. A computer system comprising:
at least one processor and memory to operate an Access Point (AP) in a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, by:
receiving an inter-AP message in a first wireless communication from a first AP of the plurality of APs, the inter-AP message comprising a destination identifier;
identifying a second AP of the plurality of APs based on the destination identifier of the inter-AP message; and
sending the inter-AP message to the second AP in a second wireless communication via the wireless downstream connection.

7. A non-transitory computer readable storage medium comprising instructions which, when executed by a computer, cause the computer to operate an Access Point (AP) in a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, by:
receiving an inter-AP message in a first wireless communication from a first AP of the plurality of APs, the inter-AP message comprising a destination identifier;
identifying a second AP of the plurality of APs based on the destination identifier of the inter-AP message; and
sending the inter-AP message to the second AP in a second wireless communication via the wireless downstream connection.

8. An Access Point (AP) in a cellular telecommunications network, the cellular telecommunications network having a plurality of APs and a core network, wherein the AP is connected to a first subset of the plurality of APs via a wireless upstream connection towards the core network and is further connected to a second subset of the plurality of APs via a wireless downstream connection away from the core network, the AP comprising:
a transceiver, memory and a processor configured to cooperate to:
receive an inter-AP message in a first wireless communication from a first AP of the plurality of APs, the inter-AP message comprising a destination identifier;
identify a second AP of the plurality of APs based on the destination identifier of the inter-AP message; and
send the inter-AP message to the second AP in a second wireless communication via the wireless downstream connection.
